(19) United States
(12) Patent Application Publication
(10) Pub. No.: US 2019/0228383 A1
(43) Pub. Date: Jul. 25, 2019

(54) SYSTEM AND METHOD OF SERVICING A VEHICLE

(71) Applicant: GM GLOBAL TECHNOLOGY OPERATIONS LLC, Detroit, MI (US)

(72) Inventors: Benjamin M. Abler, Novi, MI (US); Steven J. Ross, Livonia, MI (US); Scott A. Hammer, Berkley, MI (US)

(21) Appl. No.: 15/875,804

(22) Filed: Jan. 19, 2018

(51) Int. Cl. G06Q 10/00; G07C 5/00; G07C 9/00; G07C 5/02

(52) U.S. Cl. CPC G06Q 10/20; G07C 5/006; G06Q 30/016; G07C 9/00007; G07C 5/02; G07C 5/008

(57) ABSTRACT

A system and method for operating a vehicle. The method carried out by the system includes: determining that a vehicle needs servicing at a service facility; notifying a primary operator of the vehicle of the need for a servicing of the vehicle; receiving an authorization from the primary operatory for servicing of the vehicle during a time window; in response to receiving the authorization, wirelessly providing secure access credentials that enable operation of the vehicle during the time window without the primary operator; moving the vehicle to the service facility without the primary operator by accessing the vehicle using the access credentials and operating the vehicle either manually or autonomously along one or more roadways until it arrives at the service facility; and returning the vehicle after the servicing using the access credentials by operating the vehicle either manually or autonomously so as to drive it to a return location.

### INTRODUCTION

The disclosure relates to a system and method of operating a vehicle to provide servicing of the vehicle.

Vehicle servicing can be time consuming and tedious for vehicle primary operators (e.g., vehicle owners, lessees, or other users that have regular access to or possession of the vehicle). Often, a primary operator is required to drive the vehicle to the service facility and wait for the vehicle to be serviced. Alternatively, some service facilities may provide a temporary vehicle at a service facility for the primary operator to use while the primary operator's vehicle is being serviced, or the service provider may meet with the primary operator to obtain vehicle keys, pick up the vehicle from the primary operator's location, service the vehicle, and then return the vehicle and keys to the primary operator. All of these processes require a primary operator to be present for at least part of the vehicle servicing process.

### SUMMARY

According to a first aspect, there is provided a method of operating a vehicle to provide servicing of the vehicle including the steps of: determining that a vehicle needs servicing at a service facility; notifying a primary operator of the vehicle of the need for a servicing of the vehicle; receiving an authorization from the primary operatory for servicing of the vehicle during a time window; in response to receiving the authorization, wirelessly providing secure access credentials that enable operation of the vehicle during the time window without the primary operator; moving the vehicle to the service facility without the primary operator by accessing the vehicle using the access credentials and operating the vehicle either manually or autonomously along one or more roadways until it arrives at the service facility; and returning the vehicle after the servicing using the access credentials and by operating the vehicle either manually or autonomously so as to drive it to a return location.

In one or more particular embodiments, this method may include any one or more of the following steps or any technically feasible combination of any two or more of these steps:
notifying the primary operator when the vehicle is moved to the service facility and when the vehicle is returned to the return location;
wirelessly sending a notification to a personal handheld device carried by the primary operator;
delivering a second vehicle to the primary operator for use while the first-mentioned vehicle is being serviced;
carrying out operation of the vehicle by a person having a wireless device in which are stored the access credentials;
authenticating the authorization using at least one secure digital key associated with the primary operator and thereafter providing the access credentials in response to the authentication;
providing the access credentials to a wireless device carried by a person who moves the vehicle to the service facility;
providing the access credentials wirelessly to the vehicle and wherein the moving step comprises, in response to receiving the access credentials, autonomously operating the vehicle to move it to the service facility;
deleting the access credentials from the wireless device following the return of the vehicle to the return location; and/or
receiving the time window and an identification of a service facility location from the primary operator.

According to another aspect, there is provided a method of operating a vehicle to provide servicing of the vehicle, comprising the steps of:

notifying a primary operator of the vehicle of the need for servicing of the vehicle, wherein the notification is provided electronically to the primary operator within the vehicle or via a computing device carried by or used by the primary operator;

receiving an authorization inputted by the primary operator in response to the notification, the authorization permitting operation of the vehicle to move it to a service facility for servicing of the vehicle during a time window without involvement of the primary operator;

authenticating the authorization using at least one secure digital key associated with the primary operator;

providing secure access credentials in response to the authentication, wherein the access credentials enable operation of the vehicle during the time window without involvement of the primary operator;

moving the vehicle to the service facility without the primary operator by accessing the vehicle using the access credentials and operating the vehicle either manually or autonomously along one or more roadways until it arrives at the service facility, wherein accessing the vehicle includes verifying the access credentials at the vehicle and enabling operation of the vehicle in response to the verification;

returning the vehicle to the primary operator after the servicing by operating the vehicle either manually or autonomously so as to drive it to a return location; and

revoking use of the access credentials to operate the vehicle following return of the vehicle to the return location.

According to yet another aspect, there is provided a system for use in operating a vehicle to provide servicing of the vehicle, comprising at least one computer having one or more processors and computer readable memory storing software that is accessible by the one or more processors, wherein the system is configured to:

determine that a vehicle needs servicing at a service facility;

notify a primary operator of the vehicle of the need for servicing of the vehicle;

receive an authorization from the primary operator for servicing of the vehicle during a time window;

in response to receiving the authorization, wirelessly provide secure access credentials that enable operation of the vehicle during the time window without the primary operator;

notify the primary operator of the moving of the vehicle to the service facility, wherein the moving of the vehicle is carried out without the primary operator by accessing the vehicle using the access credentials and operating the vehicle either manually or autonomously along one or more roadways until it arrives at the service facility; and

notify the primary operator of the returning the vehicle after the servicing, wherein the returning of the vehicle is carried out using the access credentials and by operating the vehicle either manually or autonomously to drive it to a return location.

In one or more particular embodiments, this system may be configured to include any one or more of the following features or any technically feasible combination of any two or more of these features:
notify the primary operator by causing a notification to be wirelessly sent to a personal handheld device carried by the primary operator;
cause a second vehicle to be delivered to the primary operator for use while the first-mentioned vehicle is being serviced;
provide the access credentials to a wireless device carried by a person who moves the vehicle to the service facility;
authenticate the authorization using at least one secure digital key associated with the primary operator and to thereafter provide the access credentials in response to the authentication;
provide the access credentials to a wireless device carried by a person who moves the vehicle to the service facility;
provide the access credentials wirelessly to the vehicle so that the vehicle, in response to receiving the access credentials, operates autonomously to move to the service facility;
delete the access credentials from the wireless device following the return of the vehicle to the return location; and/or
receive the time window and an identification of a service facility location from the primary operator.

### BRIEF DESCRIPTION OF THE DRAWINGS

Exemplary embodiments will hereinafter be described in conjunction with the appended drawings, wherein like designations denote like elements, and wherein:

FIG. 1 is a block diagram depicting an embodiment of a communications system that is capable of utilizing the method disclosed herein; and

FIG. 2 is a flowchart illustrating a method of servicing a vehicle without the primary operator present.

### DETAILED DESCRIPTION

The system and methods below enable a vehicle servicing process without the primary operator present. Using on-board diagnostics (OBD), the vehicle may detect when servicing of the vehicle is needed and then may indicate to the primary operator the service need and provide servicing options to the primary operator. Potential vehicle services include general maintenance tasks (e.g., changing oil, replacing brakes, replacing tires, checking proper operation of lights, refilling vehicle fluids, tuning the engine) and vehicle repairs (e.g., body repair, exhaust repair, transmission repair, air conditioner repair). Servicing options notifications and other notifications may be received by the primary operator from the vehicle or from other sources (e.g., from the central facility or from the dealership facility) in a variety of ways including one or more of the following: an audio communication from an interactive vehicle audio system, a vehicle application on the primary operator's phone, an email to the primary operator, an interactive touch screen display on the instrument panel, a notification through an interactive virtual vehicle key application (i.e., virtual vehicle key app), and/or any other means known to those skilled in the art. The primary operator may respond to the vehicle by indicating a servicing time window in which the vehicle may be serviced. The time window options may be supplied to the primary operator with the notification or anytime thereafter. The time window may be specific (e.g., from a specific start time to a specific end time) or general (e.g., at any time during one or more days). Additionally, and amongst other communications, primary operators may also indicate a preferred servicing facility, agree to pricing for various services, request a temporary (e.g., loaner) vehicle, and indicate an appropriate way for the service provider to contact the primary operator throughout the servicing process.

After the service facility is designated, the vehicle will indicate to a remote facility which service provider may have access to the vehicle. The service provider may obtain a short-range wireless communications (SRWC) device (i.e., a device capable of SRWC) with a virtual vehicle key application. The remote facility can delegate vehicle access to the service provider's wireless device for the duration of the servicing time window such that the service provider's wireless device can send certain commands to the vehicle and/or permit user control of the vehicle when the service provider device is in the presence of the vehicle (e.g., within a predetermined range). In one embodiment, this access may enable the service provider to move the vehicle from its current or other pickup location to the service facility before servicing the vehicle and returning the vehicle to either the pickup location or some other designated return location. In another embodiment, the vehicle may autonomously drive itself to the service facility where the service provider's vehicle access will allow the service provider to service the vehicle before the vehicle drives itself to the designated return location. Once the vehicle has been returned to the primary operator, the service provider or the primary operator may indicate conclusion of the service to the vehicle through the virtual vehicle key application on the service provider's wireless device that indicates to the vehicle and/or the remote facility that the service is over. The remote facility can then revoke the service provider's vehicle access.

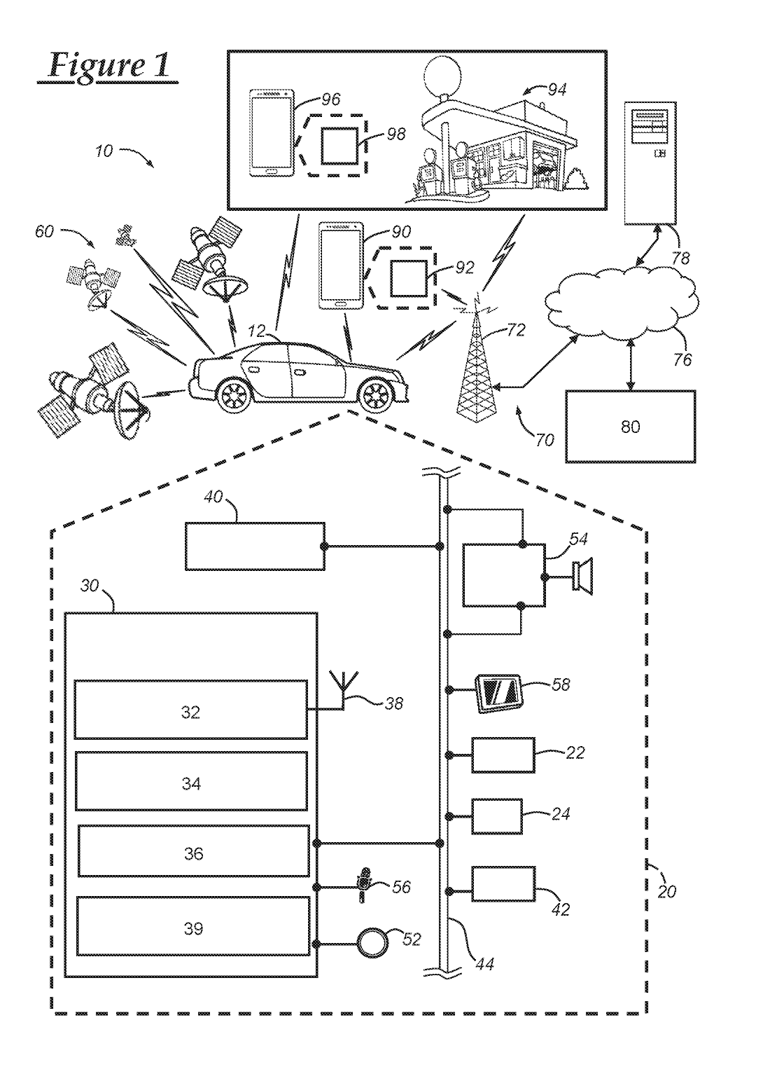

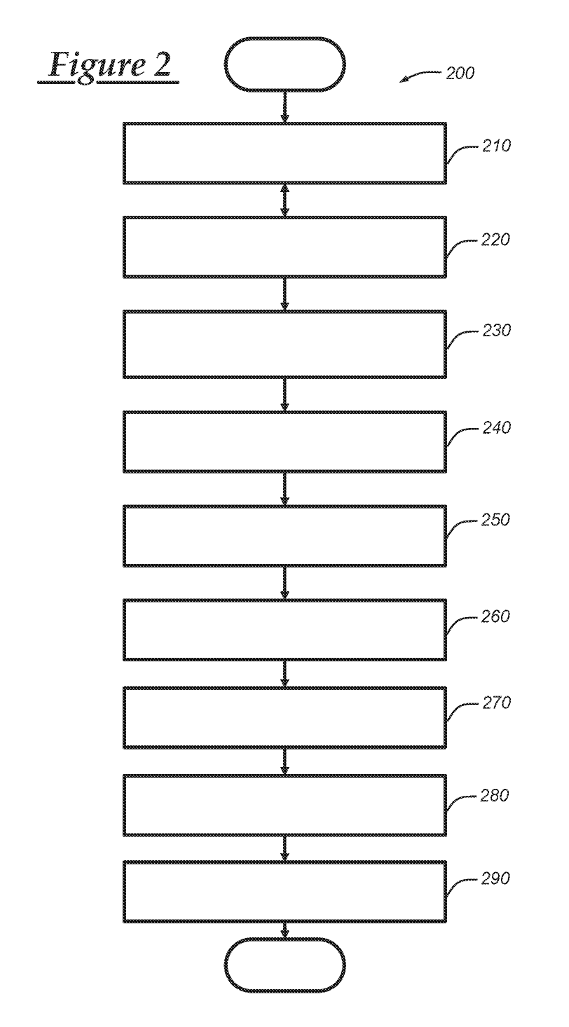

With reference to FIG. 1, there is shown an operating environment that comprises a communications system 10 that can be used to implement a method 200 (FIG. 2) disclosed herein. The communications system 10 generally includes a vehicle 12 with a wireless communications device 30, a constellation of satellites 60, a wireless carrier system 70, a land communications network 76, a computer 78, a remote facility 80, a first wireless device 90 which is used by a primary operator, and one or more other wireless devices that are used by the service provider, such as a stationary wireless device 94 or a portable wireless device 96. It should be understood that the disclosed method can be used with any number of different systems and is not specifically limited to the operating environment shown here. Also, the architecture, construction, setup, and operation of the system 10 and its individual components are generally known in the art. Thus, the following paragraphs simply provide a brief overview of a type of the vehicle communications system 10; however, other systems not shown here could employ the disclosed method as well.

The wireless carrier system 70 may be any of one or more suitable cellular telephone systems. The carrier system 70 is shown as including a cellular tower 72; however, the carrier system 70 may include one or more of the following components (e.g., depending on the cellular technology): cellular towers, base transceiver stations, mobile switching centers, base station controllers, evolved nodes (e.g., eNodeBs), mobility management entities (MMEs), serving and PGN gateways, etc., as well as any other networking components required to connect the wireless carrier system 70 with the land network 76 or to connect the wireless carrier system 70 with user equipment (UE) (e.g., the wireless communications device 30, or the wireless device 90). The wireless carrier system 70 can implement any suitable communications technology, including for example GSM/GPRS technology, CDMA or CDMA2000 technology, LTE technology, etc. In general, the wireless carrier systems 70, their components, the arrangement of their components, the interaction between the components, etc. is generally known in the art.

Apart from using the wireless carrier system 70, a different wireless carrier system in the form of satellite communication can be used to provide uni-directional or bi-directional communication with the vehicle 12. This can be done using one or more communication satellites (not shown) and an uplink transmitting station (not shown). Uni-directional communication can be, for example, satellite radio services, wherein programming content (news, music, etc.) is received by the uplink transmitting station, packaged for upload, and then sent to the satellite, which broadcasts the programming to subscribers. Bi-directional communication can be, for example, satellite telephony services using the one or more communication satellites to relay telephone communications between the vehicle 12 and the uplink transmitting station. If used, this satellite telephony can be utilized either in addition to or in lieu of the wireless carrier system 70.

The land network 76 may be a conventional land-based telecommunications network that is connected to one or more landline telephones and connects the wireless carrier system 70 to the remote facility 80. For example, the land network 76 may include a public switched telephone network (PSTN) such as that used to provide hardwired telephony, packet-switched data communications, and/or the Internet infrastructure. One or more segments of the land network 76 could be implemented through the use of a standard wired network, a fiber or other optical network, a cable network, power lines, other wireless networks such as wireless local area networks (WLANs), networks providing broadband wireless access (BWA), or any combination thereof.

The computer 78 can be one or more computers (only one shown) accessible via a private or public network such as the Internet. Each such computer 78 can be used for one or more purposes, such as a web server accessible by the vehicle 12. The other such accessible computers 78 can be, for example: a service center computer where diagnostic information and other vehicle data can be uploaded from the vehicle 12; a client computer used by the vehicle owner or other subscriber for such purposes as accessing or receiving vehicle data, setting up or configuring subscriber preferences, or controlling vehicle functions, whether by communicating with the vehicle 12, the remote facility 80, or both. The computer 78 can also be used for providing Internet connectivity such as DNS services or as a network address server that uses DHCP or other suitable protocol to assign an IP address to the vehicle 12.

The remote facility 80 may be designed to provide a vehicle electronics 20 and the wireless device 90 with a number of different system back-end functions. For example, the remote facility 80 may be used in part to implement servicing vehicle 12. In such a case, the remote facility 80 may coordinate the time window, store data pertaining to other aspects of the servicing of the vehicle 12, and/or provide authentication and authorization data to SRWC devices, users, and/or vehicles. The remote facility 80 may include one or more switches, servers, databases, live advisors, as well as an automated voice response system (VRS), all of which are known in the art. The remote facility 80 may include any or all of these various components, and preferably, each of the various components are coupled to one another via a wired or wireless local area network. The remote facility 80 may receive and transmit data via a modem connected to the land network 76. A database at the remote facility 80 can store account information such as subscriber authentication information, vehicle identifiers, profile records, behavioral patterns, and other pertinent subscriber information. Data transmissions may also be conducted by wireless systems, such as IEEE 802.11x, GPRS, and the like. Although the illustrated embodiment has been described as it would be used in conjunction with a manned remote facility 80 using a live advisor, it will be appreciated that the remote facility 80 can instead utilize a VRS as an automated advisor or, a combination of the VRS and the live advisor can be used. Information or data stored at the remote facility 80 can be sent to one or more vehicles or other devices (e.g., the wireless devices 90, 94, and 96) to carry out numerous functions and services. The vehicle 12 and the wireless devices 90, 94, and 96 can send data or information to the remote facility 80, which can then store such information.

The wireless devices 90, 94, and 96 are SRWC devices (i.e., a device capable of SRWC). These devices may include: hardware, software, and/or firmware enabling cellular telecommunications and SRWC as well as other mobile device apps, such as a virtual vehicle key app 92 or 98. The hardware of the wireless devices 90, 94, and 96 may comprise: a processor and memory (e.g., non-transitory computer readable medium accessible by the processor) for storing the software needed to implement the virtual vehicle key apps 92 and 98. The stationary facility 94 may also have one or more such apps that enable it to communicate with the computer 78, remote facility 80, and/or wireless devices 90 and 96 to exchange notifications and access credentials as needed for carrying out the methods described herein. The wireless devices 90, 94, and 96 may include various software apps (e.g., having a software app or graphical user interface (GUI)), which may be preinstalled or installed by the user (or manufacturer). One implementation of an app may enable a vehicle user to communicate with the vehicle 12 and/or control various aspects or functions of the vehicle 12, some of which are listed above. Additionally, one or more apps may allow the user to connect with the remote facility 80 or call center advisors at any time. Another implementation of an app can be the virtual vehicle key app 92 discussed below.

The processors of the wireless devices 90, 94, and 96 may also execute an operating system for the handheld device, such as Android™, iOS™, Microsoft Windows™, and/or other operating systems. The operating systems may provide a user interface and a kernel, thereby acting as a central control hub that manages the interfacing between the hardware and software of the device. Moreover, the operating systems may execute mobile apps, software programs, and/or other software or firmware instructions. The processors can execute the virtual vehicle key app 92 that enables a primary operator to make vehicle reservations for vehicle servicing and to enable operation of a virtual key via the virtual vehicle key app 98 on the service provider's wireless device 94 or 96 for use with the vehicle 12, as discussed below. The memory of the wireless device 90, 94, or 96 may include RAM, other temporary powered memory, any non-transitory computer-readable medium (e.g., EEPROM), or any other electronic computer medium that stores some or all of the software needed to carry out the various external device functions discussed herein. In other embodiments, the memory of the wireless device 90, 94, or 96 may be a non-volatile memory card, such as a Secure Digital™ (SD) card, that is inserted into a card slot of the wireless device 90, 94, or 96.

The wireless devices 90, 94, and 96 can include an SRWC circuit and/or chipset and one or more antennas, which allows it to carry out SRWC, such as any of the IEEE 802.11 protocols, WiMAX™, ZigBee™, Wi-Fi direct™, Bluetooth™, or near field communication (NFC). The SRWC circuit and/or chipset may allow the wireless device 90, 94, or 96 to connect to another SRWC device. Additionally, the wireless device 90, 94, or 96 may include a cellular chipset thereby allowing the device to communicate via one or more cellular protocols, such as GSM/GPRS technology, CDMA or CDMA2000 technology, and LTE technology. The wireless device 90, 94, or 96 may communicate data over the wireless carrier system 70 using a cellular chipset and an antenna.

A vehicle function is any function or operation that may be performed by the vehicle 12, including initiating or booting the wireless communications device 30, a GNSS module, an infotainment unit, a center stack module (CSM), or the other VSM 42. Additionally, a vehicle function may be unlocking or locking the vehicle 12 doors via a BCM, starting the ignition or primary propulsion system, heating or cooling passenger seats included in the vehicle 12, performing air conditioning or heating of the vehicle 12 cabin, turning off/on or flashing headlights or other lights included in the vehicle 12, emitting an audible sound using the vehicle 12 horn or speakers (such as those included in the audio system 54), downloading information (e.g., information pertaining to the vehicle 12 service time window) or content data (e.g., audio/video playlists or files) from the remote facility 80 or the computer 78 (including information that may be particular to the user of an SRWC device and/or associated with an SRWC device), downloading or uploading information and/or content data from or to the SRWC device, and/or performing various other operations of the vehicle 12, many of which are described herein.

In some embodiments, each of the wireless devices 90, 94, and 96 may be able to act as a passive entry key (e.g., a passive entry/passive start (PEPS) key, a smart key). For example, as discussed above, the wireless device 90, 94, or 96 may be provided a key or other information that authorizes the device to access the vehicle 12. Such a scenario may be implemented in conjunction with a car servicing process whereby the remote facility 80 coordinates the service provider's access. The remote facility 80 may generate and issue a virtual key (or digital key) (e.g., a string or array of bits) to the service provider's wireless device 96, to the primary operator's wireless device 90 and/or to the vehicle 12. The wireless device 90, 94, or 96 may then securely pass a virtual key to the vehicle 12 (e.g., via an established SRWC connection) and the vehicle 12 may then determine whether the wireless device 90, 94, or 96 is authorized to access the vehicle and/or the level of access based on the level of access the virtual key provides (e.g., full vehicle functionality, only unlocking/locking features). The app may enable such virtual key management and functionality. As will be discussed in more detail below, once the vehicle 12 successfully is reserved by the service provider using the virtual vehicle key app 98, the service provider's wireless device 94 or 96 may be enabled and authorized to control certain vehicle functions through the wireless transmission of vehicle commands and/or may be enabled for a certain time window.

In some embodiments, the service provider may use multiple of the portable wireless devices 96 or of the stationary wireless devices 94 and the primary operator may have more than one wireless device 90. One embodiment may use the portable wireless device 96 while another embodiment may instead use the stationary wireless device 94 located at or near the service facility. In another embodiment, the portable wireless device 96 may be used for part of the servicing process while the stationary wireless device 94 may be used for the other part of the servicing process. Additionally and in at least one embodiment, the primary operator may also have more than one wireless device 90, such as a work smartphone and a personal smartphone, which may be linked by the virtual vehicle key app 92.

The virtual vehicle key apps 92 and 98 are wireless device applications that may act as a vehicle key that may enable one or more of the vehicle functions. In the discussion that follows, any of the functions or other features described for one of the virtual vehicle keys app 92 and 98 may be included in the other app as well if needed or desired, and therefore, a separate discussion of those features in the other app is not included herein. The virtual vehicle key app uses the SRWC capability to provide access to the vehicle 12 within a specified distance or range from the vehicle (e.g., a fifty foot radius from the vehicle). In some embodiments, the virtual key apps 92 and 98 may also have the capability of sending and receiving information from one or more other wireless devices (e.g., the primary operator's wireless device 90 to the service provider's wireless device 94 or 96) that also have the virtual vehicle key app for purposes of transferring vehicle function access and/or for other applicable communications. In some other embodiments, the virtual key app may have the capability of communicating with the vehicle system and transferring data between the wireless application and the wireless communications device 30. The virtual vehicle key apps 92 and 98 are also capable of communicating with the remote facility 80.

The vehicle 12 is depicted in the illustrated embodiment as a passenger car, but it should be appreciated that any other vehicle 12 including motorcycles, trucks, sports utility vehicles (SUVs), recreational vehicles (RVs), marine vessels, aircraft, etc., can also be used. Some of the vehicle electronics 20 are shown generally in FIG. 1 and may include a global navigational satellite system (GNSS) module 22, an engine control unit (ECU) 24, the wireless communications device 30, an OBD system 40, a vehicle system module (VSM) 42, and numerous other components and devices. Some or all of the different vehicle electronics 20 may be connected for communication with each other via one or more communications busses. A communications bus 44 provides the vehicle electronics with network connections using one or more network protocols. Examples of suitable network connections include a controller area network (CAN), a media oriented system transfer (MOST), a local interconnection network (LIN), a local area network (LAN), and other appropriate connections such as Ethernet or others that conform with known ISO, SAE and/or IEEE standards and specifications, to name but a few.

The vehicle 12 can include more than one of the VSM 42 as part of the vehicle electronics 20, such as the GNSS module 22, the ECU 24, the wireless communications device 30, the OBD system 40, and a vehicle user interface 52, 54, 56, and 58, as will be described in detail below. The vehicle 12 can also include the other VSMs 42 in the form of electronic hardware components that are located throughout the vehicle and which may receive input from one or more sensors and use the sensed input to perform diagnostic, monitoring, control, reporting, and/or other functions. For example, the other VSMs 42 may include a center stack module (CSM), an infotainment unit, a powertrain control module, and/or a transmission control unit. Each of the VSMs 42 is preferably connected by the communications bus 44 to the other VSMs 42 as well as to the wireless communications device 30 and can be programmed to run vehicle system and subsystem diagnostic tests. One or more of the VSMs 42 may periodically or occasionally have its software or firmware updated and, in some embodiments, such vehicle updates may be over the air (OTA) updates that are received from the computer 78 or the remote facility 80 via the land network 76 and/or the wireless communications device 30. As is appreciated by those skilled in the art, the above-mentioned VSMs 42 are only examples of some of the modules that may be used in the vehicle 12, as numerous others are also possible.

The ECU 24 may control various aspects of engine operation such as fuel ignition and ignition timing. The ECU 24 is connected to the communications bus 44 and may receive operation instructions from a body control module (BCM) (not shown) or other vehicle system modules, such as the wireless communications device 30 or the VSMs 42. In one scenario, the ECU 24 may receive a command from a BCM to start the vehicle—i.e., initiate the vehicle ignition or other primary propulsion system (e.g., a battery powered motor). In another scenario, the ECU 24 may be provided a signal from a BCM that directs the ECU 24 to not perform any operations or at least to not start the vehicle's engine or primary propulsion system.

The GNSS module 22 receives radio signals from a constellation of the GNSS satellites 60. From these signals, the module 22 can determine the position of the vehicle 12 which may enable the vehicle 12 to determine whether it is at a known location, such as home or workplace. Moreover, the GNSS module 22 can provide this location data to the wireless communications device 30, which can then use this data to identify known locations, such as a vehicle operator's home or workplace. Additionally, the GNSS module 22 may be used to provide navigation and other position-related services to the vehicle operator. Navigation information can be presented on a display 58 (or other display within the vehicle) or can be presented verbally such as is done when supplying turn-by-turn navigation. The navigation services can be provided using a dedicated in-vehicle navigation module (which can be part of the GNSS module 22), or some or all navigation services can be done via the wireless communications device 30 installed in the vehicle 12, wherein the position information is sent to a remote location for purposes of providing the vehicle 12 with navigation maps, map annotations (points of interest, restaurants, etc.), route calculations, and the like. The position information can be supplied to the remote facility 80 or other remote computer system, such as the computer 78, for other purposes, such as fleet management. Also, new or updated map data can be downloaded to the GNSS module 22 from the remote facility 80 via a vehicle wireless communications device 30.

The vehicle's electronics 20 also include a number of vehicle user interfaces that provide vehicle occupants with a means of providing and/or receiving information, including a pushbutton(s) 52, an audio system 54, a microphone 56, and the visual display 58. As used herein, the term “vehicle user interface” broadly includes any suitable form of electronic device, including both hardware and software components, which is located on the vehicle and enables a vehicle user to communicate with or through a component of the vehicle. The pushbutton(s) 52 allow manual user input into the wireless communications device 30 to provide other data, response, or control input. The audio system 54 provides audio output to a vehicle occupant and can be a dedicated, stand-alone system or part of the primary vehicle audio system 54. According to the particular embodiment shown here, the audio system 54 is operatively coupled to both the vehicle bus 44 and an entertainment bus (not shown) and may provide AM, FM, and satellite radio, CD, DVD and other multimedia functionality. This functionality can be provided in conjunction with or independent of an infotainment module. The microphone 56 provides audio input to the wireless communications device 30 to enable the driver or other occupant to provide voice commands and/or carry out hands-free calling via the wireless carrier system 70. For this purpose, it can be connected to an on-board automated voice processing unit utilizing human-machine interface (HMI) technology known in the art. The visual display or touch screen display 58 is preferably a graphics display on the instrument panel or a heads-up display reflected off of the windshield and can be used to provide a multitude of input and output functions. Various other vehicle user interfaces can also be utilized, as the interfaces shown in FIG. 1 are only an example of one particular implementation.

The wireless communications device 30 includes a cellular chipset 32, a processor 34, a memory 36, an antenna 38 (e.g., a single antenna, dual antenna, or any appropriate number of antennas), and an SRWC circuit 39. The wireless communications device 30 can be an OEM-installed (embedded) or aftermarket device that is installed in the vehicle 12 and that enables wireless voice and/or data communication over the wireless carrier system 70 and via wireless networking. This enables the vehicle 12 to communicate with the remote facility 80, other telematics-enabled vehicles, or some other entity or device. The wireless communications device 30 can use radio transmissions to establish a communications channel (a voice channel and/or a data channel) with the wireless carrier system 70 so that voice and/or data transmissions can be sent and received over the channel. By providing both voice and data communication, the wireless communications device 30 enables the vehicle 12 to offer a number of different services including those related to vehicle servicing, navigation, car sharing, telephony, emergency assistance, diagnostics, infotainment, etc. Data can be sent either via a data connection, such as via packet data transmission over a data channel or via a voice channel using techniques known in the art. For combined services that involve both voice communication and data communication, the system can utilize a single call over a voice channel and switch as needed between voice and data transmission over the voice channel, and this can be done using techniques known to those skilled in the art.

According to one embodiment, the wireless communications device 30 utilizes cellular communication according to either GSM, CDMA, or LTE standards and, thus, includes the standard cellular chipset 32 for voice communications like hands-free calling, a wireless modem for data transmission, an electronic processing device 34, one or more of the digital memory devices 36, and/or the dual antenna 38. It should be appreciated that the modem can either be implemented through software that is stored in the wireless communications device and is executed by the processor 34, or it can be a separate hardware component located internal or external to the wireless communications device 30. The modem can operate using any number of different standards or protocols such as LTE, EVDO, CDMA, GPRS, and EDGE. Wireless networking between the vehicle 12 and other networked devices can also be carried out using the wireless communications device 30. For this purpose, the wireless communications device 30 may use the SRWC circuit 39 to communicate wirelessly according to one or more wireless protocols, including SRWC such as any of the IEEE 802.11 protocols, WiMAX, ZigBee™, Wi-Fi™ direct, Bluetooth™, Bluetooth Low Energy™ (BLE), or near field communication (NFC). When used for packet-switched data communication such as TCP/IP, the wireless communications device can be configured with a static IP address or can set up to automatically receive an assigned IP address from another device on the network such as a router or from a network address server.

The processor 34 can be any type of device capable of processing electronic instructions including microprocessors, microcontrollers, host processors, controllers, vehicle communication processors, and application specific integrated circuits (ASICs). It can be a dedicated processor used only for the wireless communications device 30 or can be shared with other vehicle systems. The processor 34 executes various types of digitally-stored instructions, such as software or firmware programs stored in the memory 36, which enable the wireless communications device to provide a wide variety of services. For instance, the processor 34 can execute programs or process data to carry out at least a part of the method discussed herein.

In some embodiments, the wireless communications device 30 can be used to provide a diverse range of vehicle services that involve wireless communication to and/or from the vehicle 12. Such services may include: turn-by-turn directions and other navigation-related services that are provided in conjunction with the GNSS module 22; airbag deployment notification and other emergency or roadside assistance-related services that are provided in connection with one or more collision sensor interface modules such as a body control module (not shown); diagnostic reporting using one or more diagnostic modules; and/or infotainment-related services where music, webpages, movies, television programs, videogames and/or other information is downloaded by an infotainment module (not shown) and is stored for current or later playback. The above-listed services are by no means an exhaustive list of all of the capabilities of the wireless communications device 30, but are simply an enumeration of some of the services that the wireless communications device may be capable of offering. Furthermore, it should be understood that at least some of the aforementioned modules could be implemented in the form of software instructions saved internal or external to the wireless communications device 30. The aforementioned modules could be hardware components located internal or external to the wireless communications device 30, or they could be integrated and/or shared with each other or with other systems located throughout the vehicle 12, to cite but a few possibilities. In the event that the modules are implemented as the VSMs 42 located external to the wireless communications device 30, they could utilize the vehicle bus 44 to exchange data and commands with the wireless communications device 30.

In reference to FIG. 2, there is shown an embodiment of the method 200 of operating the vehicle to provide servicing. In some scenarios, certain embodiments of method 200 may enable the servicing the vehicle 12 without the primary operator present. The method 200 may be carried out in part or in whole by the vehicle 12.

The method 200 begins with step 210 wherein there is a determination that a vehicle needs servicing at a servicing facility. A vehicle may determine whether service is desirable by using the OBD system 40 or other comparable means. For example, the ECU 24 may detect a problem, generate an OBD Trouble Code (OTC), and send the code to the OBD system which may then be relayed to the primary operator. Alternatively, the dealer, service facility, or central facility may detect the need for service via service records, pre-determined time lines (e.g., the manufacturer's suggested maintenance time lines), previously scheduled maintenance, and/or other indicating factors. The method 200 continues to step 220.

In step 220, the primary operator of the vehicle is notified of the need for servicing the vehicle. This may be done directly from the remote facility 80, stationary wireless device 94, or other central facility, or may be done via the vehicle either based on an OTC code or via a message received by the vehicle from the remote facility 80. Communication with the primary operator may take several different forms, such as via the vehicle or a computing device carried or used by the primary operator. In particular, non-limiting examples include communicating wirelessly through the primary operator's wireless device 90, communicating through the instrument panel interactive touch screen display 58 that enables visual communication, communicating verbally through the vehicle's audio system 54, through sending an email or other wireless message to the primary operator, or by any other means of communicating between the vehicle 12 and a primary operator. The vehicle's communication to a primary operator may be a bilateral communication with a primary operator which may include responding to a series of prompts from the vehicle. For example, the vehicle 12 may prompt the primary operator to input notification preferences, payment preferences, and contact preferences which may then be relayed to the service provider. Alternatively, the notifications may be provided to the operator from the vehicle or remote facility via other means such as the virtual vehicle key app 92.

Additionally, the primary operator may also be able to request servicing information via the vehicle, the virtual vehicle key app 92, or other user communication device. Non-limiting examples of servicing information are the service(s) needed, average time the service(s) take, list of service facilities for the primary operator to choose from, information about a selected facility, time windows available for the service(s) at the selected facility, whether having a second vehicle (e.g., a temporary complimentary vehicle or a rented vehicle) delivered during the servicing time is an option, average pricing for the service(s) at each location, payment options at different facilities, ratings of different facilities, and any other information a primary operator may need or would like to know for deciding the location and time window for servicing the vehicle 12. Based on certain user input, the vehicle 12, the virtual vehicle key app 92, or other user communication device may need more information such that the vehicle may sufficiently respond to the primary operator's requests. This may include communicating wirelessly with a number of service providers to obtain information about pricing, time windows available for service, second trade-out car availability, and other relevant information. Additionally, the vehicle 12, the virtual vehicle key app 92, or other user communication device may download information (e.g., which service facilities provide the needed vehicle 12 services, ratings of service facilities) from the Internet when responding to the primary operator's questions and/or selections. If the wireless device 90 is used for notification and/or scheduling of service, the virtual vehicle key app 92 may open browsers or additional apps in response to a primary operator's request(s) and/or selection(s). At the end of the communication, the primary operator may have an identified service facility location and servicing time window. The method 200 continues to step 230.

In step 230, authorization is received from the primary operator for servicing of the vehicle during the time window. This authorization may be inputted by the primary operator, for example, by input to the vehicle via a part of the vehicle user interface 52, 56, 58, or by input into the virtual vehicle key app 92 in response to a prompt requesting the authorization. In order to confirm that the authorization is received from the primary operator and not some other source, authentication may be needed. Authentication may include receiving a digital key from the primary operator's wireless device 90. This can be done by comparing the digital key with a corresponding key stored at the remote facility 80, or by performing a hash function on a key and comparing it to a stored hash, or by other methods of authentication known to those skilled in the art. Authentication could also be done based on a primary operator's login information or credentials that are sent from the virtual vehicle key app 92 on the primary operator's wireless device 90 to the remote facility 80 and/or on confirmation that the vehicle 12 is associated with a primary operator based on a record lookup of a primary operator's account. Once authorization has been obtained, the vehicle 12 may be able to confirm a designated time window with a service provider and reserve a time window for the designated services. If a second vehicle is requested, this information may be used to reserve the second vehicle and a confirmation can be sent to the primary operator. Additional information such as the primary operator's personal information, a vehicle's 12 license plate, a geographical location of the vehicle 12, and other forms of applicable information may be relayed wirelessly to a service provider prior to the beginning of a servicing time window. The method 200 continues to step 240.

In step 240, in response to receiving the authorization, secure access credentials are wirelessly provided that enable operation of the vehicle during the time window without the primary operator. In some embodiments, step 240 may occur within a reasonable timeframe before or at the beginning of a designated service time window. Before credentials are provided, authorization and/or authentication of the service provider and/or device 96 may be determined. This may be carried out using the virtual vehicle key app 92 which, thereafter, can be used to control at least some of the vehicle's functions. This step may be implemented by carrying out one or more wireless messages between the vehicle 12 and the service provider's wireless device 94 or 96. The vehicle 12 will receive an encrypted digital key code from the remote facility 80 and send the encrypted digital key code wirelessly to the service provider's wireless device 94 or 96, creating a wireless communication connection between the vehicle and service provider. If a virtual key continues to update an encrypted key code, the vehicle 12 will continue sending the updated key code to a service provider for the duration of a servicing time window. In another embodiment, the vehicle 12 will relay a servicing time window to the remote facility 80, and the remote facility will send a key code to the service provider's wireless device 94 or 96 for the duration of the servicing time window. In yet another embodiment, the primary operator's virtual vehicle key app 92 may be used to manage the notifying, sending, and receiving of the service key(s) by, for example, sending a key code to the service provider's virtual vehicle key app 98. The access credentials are stored in the service provider's wireless device 94, 96 for the duration of the servicing time window. The method 200 continues to step 250.

In step 250, the primary operator of the vehicle is notified of the need for servicing of the vehicle, wherein the notification is provided electronically or wirelessly to the primary operator within the vehicle or via a computing device carried by or used by the operator. This notification may be done at the time of requesting/receiving authorization from the primary operator (step 230) or later as a reminder shortly in advance of the servicing or when the servicing begins (e.g., when the vehicle is moved to the service location). In at least one embodiment, this step notifies a primary operator that the vehicle 12 will be unavailable for the previously specified time window and allows a primary operator to prepare for potential communications with a service provider regarding any servicing issues or other necessary communications. If a temporary car is furnished for a primary operator's convenience, the vehicle information and authorization may be given to the primary operator at this time. This authorization may be, for example, secure credentials that allow the primary operator to access the temporary car via the virtual vehicle key app 92. The method 200 continues to step 260.

In step 260, the vehicle is moved to the service facility without the primary operator by accessing the vehicle 12 using the access credentials and operating the vehicle 12 either manually or autonomously along one or more roadways until it arrives at the facility. In one embodiment, the vehicle 12 is moved to a service facility manually by a service provider person. In this scenario, the service provider's portable wireless device 96 may be used. This wireless device 96 may have SRWC capability and the credentials (e.g., the virtual key as described above) may be provided to the service provider via the service provider's stationary wireless device 94 or via the remote facility 80 or other central facility by communication with the virtual vehicle key app 98. In another embodiment, the vehicle 12 autonomously drives itself to a service facility. In this scenario, the service provider's wireless devices 94 or 96 may not be needed to provide the vehicle access; rather, the access credentials may be provided directly to the vehicle itself along with the destination information (service location) such that the vehicle may confirm that access and autonomous operation of the vehicle to move it to the service location is authorized. Then, when the designated service time window occurs, the vehicle may then autonomously move to the service facility at the service location. This autonomous operation may involve yet another notification and request for approval confirmation (e.g., at the start of the time window) that is sent to the primary operation via the virtual vehicle key app 92, or otherwise, to make certain that the vehicle is available from the primary operator for service.

In yet another embodiment, the vehicle 12 may drive itself autonomously for part of the distance to or within the service facility and a service provider may drive the vehicle 12 the other part of the distance to a service facility. In this scenario, the service provider may use the portable wireless device 96 to receive the access credentials needed to move the vehicle. Or, if such manual operation of the vehicle 12 is only done at the service facility, then the credentials may be obtained and used only by the stationary wireless device 94, with SRWC being used at the service facility to communicate with the vehicle 12 to obtain the needed access to operate the vehicle locally within the range of the SRWC. The method 200 continues to step 270.

In step 270, the vehicle is returned to the primary operator after servicing by operating the vehicle either manually or autonomously so as to drive it to a return location designated by the primary operator. The primary operator may designate the return location in advance, upon notification that the service is complete, or at any time there-between. In one embodiment, the vehicle 12 is moved to a return location manually by a service provider person. In this scenario, the service provider's wireless device 96 would need to be the hand-held or portable wireless device, such as a smartphone. In another embodiment, the vehicle 12 autonomously drives itself to a return location. In yet another embodiment, the vehicle 12 could drive itself autonomously for part of the distance to a return location and a service provider could drive the vehicle 12 the other part of the distance to a return location. In this scenario, a service provider would need to use the portable wireless device 96 for at least the transportation of a vehicle. The method 200 continues to step 280.

In step 280, a primary operator is notified that a service is complete and the vehicle 12 has been dropped off at a return location. The return location does not need to be the same location from which the vehicle 12 was originally received for servicing. If a second vehicle was provided to a primary operator, a service provider would also pick up the second vehicle at the same time a primary operator's vehicle 12 is returned. The method 200 continues to step 290, wherein the access credentials to operate the vehicle (i.e., the virtual key code) following the return of the vehicle to the return location is revoked. This revocation may occur by a command sent from the primary operator's wireless device 94 or 96, the remote facility 80, or the vehicle 12 itself. For instance, the remote facility 80, vehicle, or primary operator's wireless device 90 may delete or modify information sent to the service provider's wireless device 94, 96. The method 200 ends.

It is to be understood that the foregoing is a description of one or more embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation. In addition, the term “and/or” is to be construed as an inclusive or. As an example, the phrase “A, B, and/or C” includes: “A”; “B”; “C”; “A and B”; “A and C”; “B and C”; and “A, B, and C.”

1. A method of operating a vehicle to provide servicing of the vehicle, comprising the steps of:
determining that a vehicle needs servicing at a service facility;
notifying a primary operator of the vehicle of the need for servicing of the vehicle;
receiving an authorization from the primary operator for servicing of the vehicle during a time window;
in response to receiving the authorization, wirelessly providing secure access credentials that enable operation of the vehicle during the time window without the primary operator;
moving the vehicle to the service facility without the primary operator by accessing the vehicle using the access credentials and operating the vehicle either manually or autonomously along one or more roadways until it arrives at the service facility; and
returning the vehicle after the servicing using the access credentials and by operating the vehicle either manually or autonomously so as to drive it to a return location.

2. The method set forth in claim 1, further comprising the steps of notifying the primary operator when the vehicle is moved to the service facility and when the vehicle is returned to the return location.

3. The method set forth in claim 1, wherein the notifying step further comprises wirelessly sending a notification to a personal handheld device carried by the primary operator.

4. The method set forth in claim 1, further comprising the step of delivering a second vehicle to the primary operator for use while the first-mentioned vehicle is being serviced.

5. The method set forth in claim 1, wherein operating the vehicle during the moving and returning steps is carried out by a person having a wireless device in which are stored the access credentials.

6. The method set forth in claim 1, wherein the step of wirelessly providing the access credentials further comprises authenticating the authorization using at least one secure digital key associated with the primary operator and thereafter providing the access credentials in response to the authentication.

7. The method set forth in claim 6, wherein the access credentials are provided to a wireless device carried by a person who moves the vehicle to the service facility.

8. The method set forth in claim 6, wherein the access credentials are provided wirelessly to the vehicle and wherein the moving step comprises, in response to receiving the access credentials, autonomously operating the vehicle to move it to the service facility.

9. The method set forth in claim 8, further comprising the step of deleting the access credentials from the wireless device following the return of the vehicle to the return location.

10. The method set forth in claim 1, further comprising receiving the time window and an identification of a service facility location from the primary operator.

11. A method of operating a vehicle to provide servicing of the vehicle, comprising the steps of:
notifying a primary operator of the vehicle of the need for servicing of the vehicle, wherein the notification is provided electronically to the primary operator within the vehicle or via a computing device carried by or used by the primary operator;
receiving an authorization inputted by the primary operator in response to the notification, the authorization permitting operation of the vehicle to move it to a service facility for servicing of the vehicle during a time window without involvement of the primary operator;
authenticating the authorization using at least one secure digital key associated with the primary operator;
providing secure access credentials in response to the authentication, wherein the access credentials enable operation of the vehicle during the time window without involvement of the primary operator;
moving the vehicle to the service facility without the primary operator by accessing the vehicle using the access credentials and operating the vehicle either manually or autonomously along one or more roadways until it arrives at the service facility, wherein accessing the vehicle includes verifying the access credentials at the vehicle and enabling operation of the vehicle in response to the verification;
returning the vehicle to the primary operator after the servicing by operating the vehicle either manually or autonomously so as to drive it to a return location; and
revoking use of the access credentials to operate the vehicle following return of the vehicle to the return location.

12. A system for use in operating a vehicle to provide servicing of the vehicle, comprising at least one computer having one or more processors and computer readable memory storing software that is accessible by the one or more processors, wherein the system is configured to:
determine that a vehicle needs servicing at a service facility;
notify a primary operator of the vehicle of the need for servicing of the vehicle;
receive an authorization from the primary operator for servicing of the vehicle during a time window;
in response to receiving the authorization, wirelessly provide secure access credentials that enable operation of the vehicle during the time window without the primary operator;
notify the primary operator of the moving of the vehicle to the service facility, wherein the moving of the vehicle is carried out without the primary operator by accessing the vehicle using the access credentials and operating the vehicle either manually or autonomously along one or more roadways until it arrives at the service facility; and
notify the primary operator of the returning the vehicle after the servicing, wherein the returning of the vehicle is carried out using the access credentials and by operating the vehicle either manually or autonomously to drive it to a return location.

13. The system defined in claim 12, wherein the system is configured to notify the primary operator by causing a notification to be wirelessly sent to a personal handheld device carried by the primary operator.

14. The system defined in claim 12, wherein the system is configured to cause a second vehicle to be delivered to the primary operator for use while the first-mentioned vehicle is being serviced.

15. The system defined in claim 12, wherein the system is configured to provide the access credentials to a wireless device carried by a person who moves the vehicle to the service facility.

16. The system defined in claim 12, wherein the system is configured to authenticate the authorization using at least one secure digital key associated with the primary operator and to thereafter provide the access credentials in response to the authentication.

17. The system defined in claim 16, wherein the system is configured to provide the access credentials to a wireless device carried by a person who moves the vehicle to the service facility.

18. The system defined in claim 16, wherein the system is configured to provide the access credentials wirelessly to the vehicle so that the vehicle, in response to receiving the access credentials, operates autonomously to move to the service facility.

19. The system defined in claim 18, wherein the system is configured to delete the access credentials from the wireless device following the return of the vehicle to the return location.

20. The system defined in claim 12, wherein the system is configured to receive the time window and an identification of a service facility location from the primary operator.
